(19) United States
(12) Patent Application Publication
(10) Pub. No.: US 2008/0291275 A1
(43) Pub. Date: Nov. 27, 2008

(54) Video Data Processor Device for a Motor Vehicle

(75) Inventors: Vincent Hubert, Pontoise (FR); Marc Semelle, Montigny-le-Bretonneux (FR)

Correspondence Address: OLIFF & BERRIDGE, PLC, P.O. BOX 320850, ALEXANDRIA, VA, 22320-4850, US

(73) Assignee: Valeo Etudes Electroniques, Creteil (FR)

(21) Appl. No.: 12/083,346

(22) PCT Filed: Oct. 11, 2006
(86) PCT No.: PCT/FR2006/051017

§ 371 Date: Jun. 17, 2008

(30) Foreign Application Priority Data
Oct. 12, 2005 (FR) 0510422

(51) Int. Cl. H04N 7/18

(52) U.S. Cl. 348/148; 348/E07.085

(57) ABSTRACT

This device for processing video data (10) comprises at least one video image acquisition unit (14). The unit (14) includes means (32) for generating an initial video image, the video image being defined by a video data set. The device further comprises means for transmitting data between the image acquisition unit (14) and an on-board computer (16), and image-creator means for creating a useful video image from the initial video image. The image-creator means comprise means (34) for adjustably selecting at least a portion of the initial video image, the selected portion constituting at least a portion of the useful image.

The present invention relates to a video data processor device for a motor vehicle.

In the state of the art, there is already known a video data processor device for a motor vehicle, the device comprising at least one video image acquisition unit including means for generating an initial video image, the video image being defined by a video data set, means for transmitting data between the image acquisition unit and an on-board computer, and image-creator means for creating a useful video image from the initial video image.

The video image acquisition unit generally comprises a video camera, e.g. placed at the rear of the vehicle.

The on-board computer is generally connected to a screen displaying the video image coming from the image acquisition unit.

The driver can thus see obstacles behind the vehicle by looking at the image on the screen.

The initial video image generated by the image acquisition unit is generally transmitted in full to the on-board computer. Consequently, the screen connected to the on-board computer displays a useful video image that is created from the initial video image and that corresponds to said initial video image.

Generally, in order to ensure that the useful video image as displayed on the screen is relevant, it is appropriate to adjust accurately the position of the image acquisition unit on the vehicle. For this purpose, it is common practice to provide electromechanical means for adjusting the position of the acquisition unit and making it possible to take account of variations in the trim of the vehicle or slow drift in the position of the acquisition unit caused by the vibration to which said image acquisition unit is subjected.

A particular object of the invention is to avoid having recourse to such electromechanical adjustment means that are relative expensive and complex.

To this end, the invention provides a video data processor unit of the above-specified type, characterized in that the image-creator means comprise adjustable selector means for selecting at least a portion of the initial video image, the selected portion constituting at least a portion of the useful image.

By means of the invention, the useful image for display on the screen that can be seen by the driver is constituted by an adjustable selection of at least a portion of the initial video image acquired by the video image acquisition unit. Thus, to obtain a useful image that is relevant, it suffices to select a relevant portion of the initial video image. The selection may be adjusted as a function of variations in the trim of the vehicle and/or variations in the position of the camera as a function of the vibration to which the camera is subjected.

Thus, the invention makes it possible to replace the electromechanical means for adjusting the position of the camera by software means for selecting a portion of an initial video image.

According to other characteristics of the video data processor device that are optional:
the video image acquisition unit includes means for forming an optical image having an angular field of view greater than 120°, from which the initial video image is generated;
the means for forming the optical image comprise a fish-eye type lens;
the image-creator means include means for adjustably selecting at least two portions of the initial video image, the selected portions constituting at least two portions of the useful image; and
the device comprises two video image acquisition units, the useful video image being constituted by two portions selected respectively from the two initial video images generated respectively by the two video image acquisition units.

The invention can be better understood on reading the following description, given purely by way of example and made with reference to the accompanying drawings, in which:

FIG. 1 is a diagrammatic view of a motor vehicle including a video data processor device constituting a first embodiment of the invention;

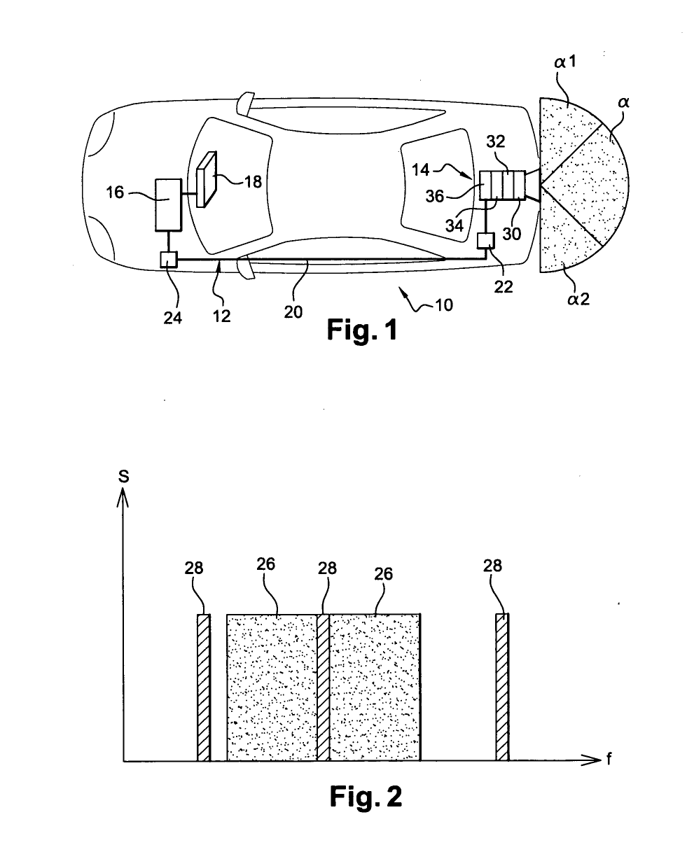

FIG. 2 is a graph showing a frequency spectrum for first and second digital signals corresponding respectively to video data and to control data;

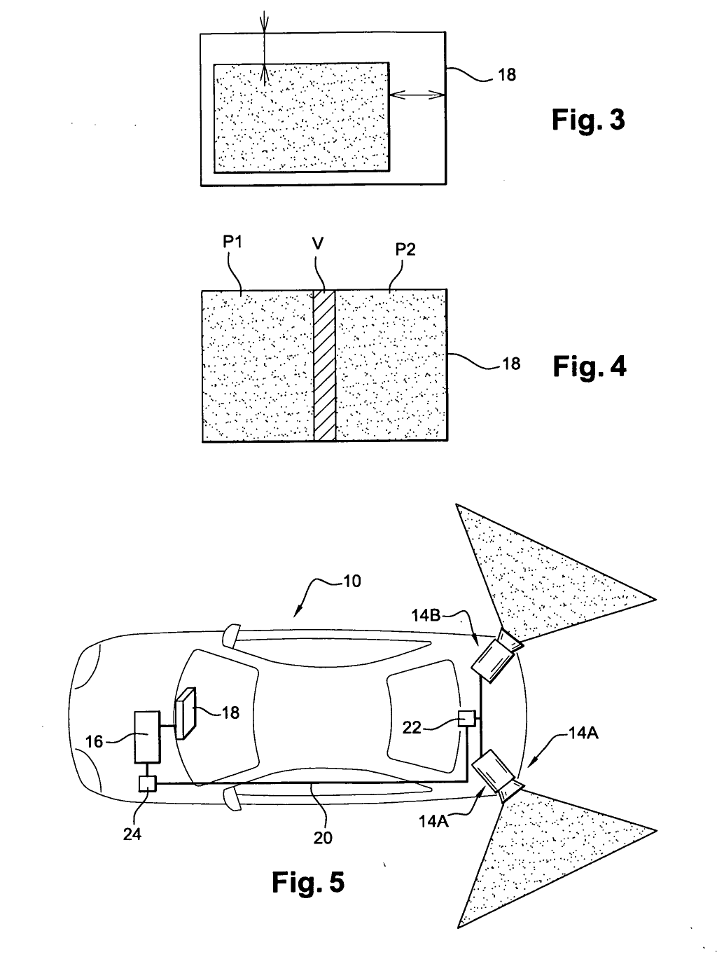

FIG. 3 is a diagrammatic view of a screen of the video data processor device shown in FIG. 1 for displaying a useful video image;

FIG. 4 is a view similar to FIG. 3 showing another useful image;

FIG. 5 is a view similar to FIG. 1 showing a motor vehicle provided with a video data processor device constituting a second embodiment of the invention;

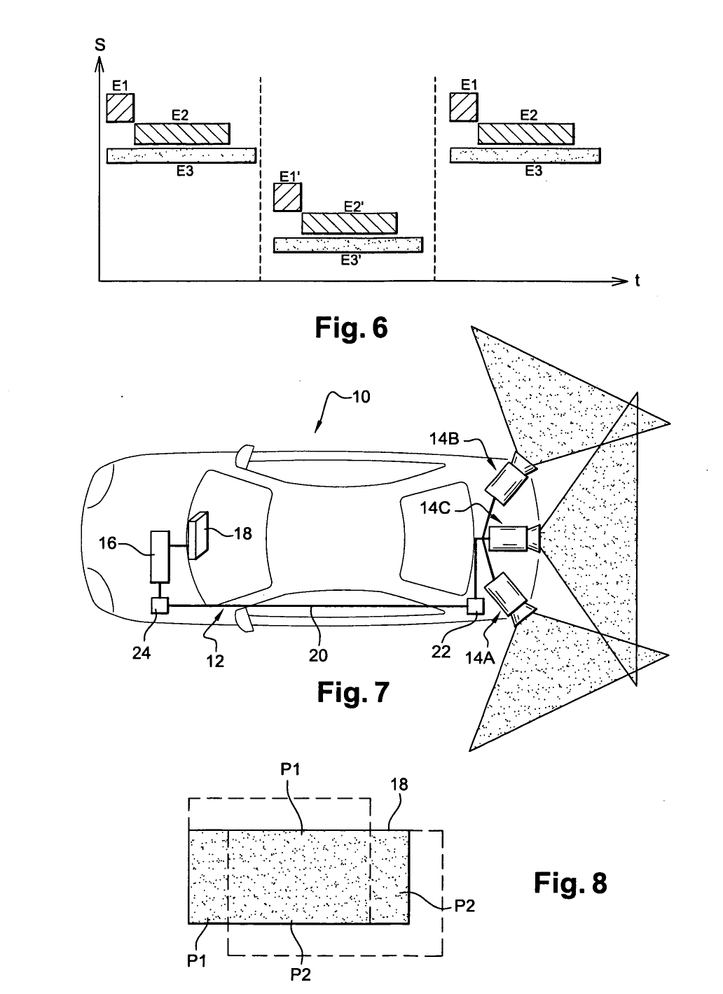

FIG. 6 is a graph showing a succession of digital signals comprising video data and control data as transmitted in the video data processor device shown in FIG. 5;

FIG. 7 is a view similar to FIG. 1 of a motor vehicle provided with a video data processor device constituting a third embodiment of the invention; and

FIG. 8 is a view of a screen showing a useful image obtained from the video data processor device shown in FIG. 7.

FIG. 1 shows a motor vehicle provided with a video data processor device constituting a first embodiment of the invention. The processor device is given overall reference 10.

The processor device 10 comprises a communications system 12 for communicating between a video image acquisition unit 14 and an on-board computer 16 of the motor vehicle.

The computer 16 is connected to a conventional screen 18 for displaying a useful video image that is visible to the driver of the vehicle.

The communications system 12 includes carrier current data transmission means comprising a data transmission line 20 forming a circuit for electrically powering various members of the motor vehicle, and in particular the video image acquisition unit 14.

The communications system 12 also comprises first means 22, e.g. a conventional module for carrier current data transmission, for putting a video data set into the form of a first digital signal, and second means 24, e.g. a second conventional module for carrier current data transmission, for putting a control data set into the form of a second digital signal.

As can be seen in FIG. 2, the first digital signal (video data) is transmitted by a first set 26 of carrier frequencies, and the second digital signal (control data) is transmitted by a second set 28 of carrier frequencies.

The video image acquisition unit 14 includes means 30 for forming an optical image, which means comprise, in the first embodiment described, an objective lens of the fish-eye type. This lens serves to form an optical image having an angular field of view of greater than 120°.

The video image acquisition unit 14 also includes conventional means 32 for generating an initial video image from the optical image formed by the means 30.

The video image acquisition unit 14 also includes means for creating a useful video image from the initial video image as generated by the means 32. These useful video image image-creator means comprise adjustable connector means 34 for adjustably selecting at least a portion of the initial video image, the selected portion constituting at least a portion of the useful video image.

The video image acquisition unit 14 also includes means 36 for selecting carrier frequencies of the first set 26 of carrier frequencies (data signal), as a function of a predefined criterion.

In a variant, the carrier frequency selector means 36 could be arranged in some other element of the communications system 12.

The main aspects of a method for communication between the image acquisition unit 14 and the on-board computer 16 are described below.

During this method, data is transmitted by carrier current, making use of the transmission line 20 between the video image acquisition unit 14 and the on-board computer 16. In a variant, the data could be transmitted with the help of other conventional means, e.g. means comprising distinct transmission lines for the video data and for the control data.

Initially, the means 34 are used to select a portion of the initial video signal generated by the means 22, e.g. a portion corresponding to a central spherical angular sector a of the optical image formed by the fish-eye lens, as shown in FIG. 1. The portion selected is for constituting the useful video image.

Where present, the portion of the initial video image that is selected is adjusted in order to take account of variations in the position of the video image acquisition unit 14 with this being done with the help of a conventional user interface and software means included in the on-board computer 16.

FIG. 3 has arrows representing the abscissa and ordinate adjustments that it is possible to apply to the useful image as displayed on the screen 18 by adjusting which portions of the initial video image are selected.

Where appropriate, the adjustable selector means 34 enable at least two portions of the initial video image to be selected, e.g. two side spherical angular sectors α1 and α2 that are disjoint in the optical image, as shown in FIG. 1.

The selected portions of the initial video image constitute at least two portions P1, P2 of the useful image, as shown in FIG. 4.

The two useful image portions P1, P2 may optionally be separated by a vertical strip V informing the user that the useful image portions P1, P2 come from two disjoint portions of the optical image.

The selected portion of the initial video image forms a video data set that is put into the form of the first digital signal with the help of the means 22. This first signal is for sending to the screen 18 via the computer 16.

Before transmitting the video data set or a portion of this video data set, the means 36 are used to select the carrier frequencies for the first carrier frequency 26 as a function of a predefined criterion.

By way of example, this criterion may be associated with the error rate in the transmission of test data between the on-board computer 16 and the video image acquisition unit 14.

Thus, test data is transmitted over all of the carrier frequencies usable for transmitting video data, and then as a function of an error rate in the transmission of the test data, those carrier frequencies that are the most disturbed are eliminated so as to conserve as a general rule about 80% of the potential carrier frequencies.

In a variant, the criterion is associated with an attenuation level for a characteristic of the test signal transmitted between the on-board computer 16 and the video image acquisition unit 14. For example, the signal characteristic may be an amplitude of the test signal.

Furthermore, the video image acquisition unit 14 and the on-board computer 16 also exchange control data for the video image acquisition unit 14, e.g. to adjust parameters or the position of the video image acquisition unit, to activate or deactivate the video image acquisition unit, etc.

Thus, the video image acquisition unit 14 is controlled in particular in order to enable it to acquire a new initial video image.

For this purpose, a control data set is formed with the help of the means 24 so as to constitute a second digital signal that is transmitted from the on-board computer 16 to the unit 14 using the second set of carrier frequencies 28.

In order to able to transmit the video data at a rate that is sufficiently high from the unit 14 to the computer 16 and the screen 18, the number of carrier frequencies in the first set 26 (video data) is greater than the number of carrier frequencies in the second set 28 (control data).

Preferably, the carrier frequencies of the first and second sets 26 and 28 of carrier frequencies are selected from at least 100 successive carrier frequencies, e.g. 128 carrier frequencies.

The 128 successive carrier frequencies are distributed for example over the range 2 megahertz (MHz) to 30 MHz.

In the example shown in FIG. 2, the carrier frequencies of the second set 28 (control data) are located to the left, to the right, and substantially in the middle of the carrier frequencies of the first set 26 (video data). In a variant, the carrier frequencies of the second set 28 could be situated solely to the left of the carrier frequencies of the first set 26, or solely to the right of the carrier frequencies of the first set 26, or indeed solely between carrier frequencies of the first set 26.

FIGS. 5 to 8 show video data processor devices 10 constituting second and third embodiments of the invention.

In these figures, elements analogous to those in the preceding figures are identified by identical references.

The processor device 10 of the second embodiment shown in FIG. 5 comprises two video image acquisition units 14A, 14B analogous to the above-described video image acquisition unit 14.

These two units 14A, 14B are connected to the same line 20 for transmitting data by carrier current.

Preferably, and as shown in FIG. 6, a control data set E1 is sent for the attention of a first one 14A of these two image acquisition units and a video data set E2 is acquired by means of the first unit 14A, while at the same time a video data set E3 that has been already acquired by the second one 14B of the two image acquisition units is sent for the attention of the on-board computer 16.

Once E3 has been sent, a control data set E1′ is sent for the attention of the second unit 14B and a video data set E2′ is acquired by means of the second unit 14B, while a video data set E3′ that has been already acquired by the first unit 14A is sent for the attention of the on-board computer 16, etc.

For reasons of clarity, in FIG. 6, the sending of the data set E1′ is shown separated from the sending of the data set E3. Nevertheless, in general, the sending of the set E1′ follows on directly from the sending of the set E3.

In this second embodiment, each unit 14A, 14B generates an initial video image and the adjustable selector means 32 of each unit 14A, 14B select a portion of the corresponding initial video image.

The two selected portions of the two initial video images constitutes at least two useful image portions P1, P2, as shown in FIG. 4.

The data processor device 10 constituting the third embodiment as shown in FIG. 7 has three video image acquisition units 14A, 14B, 14C analogous to the above-described video image acquisition unit 14.

These three units 14A, 14B, 14C are connected to the same line 20 for transmitting data by carrier current.

As for the second embodiment, a control data set is sent to the attention of the first of the three video image acquisition units 14A, 14B, 14C and a video data set can be acquired by said first of these three image acquisition units while a second one of the three image acquisition units is sending for the attention of the on-board computer 16 a video data set that has been acquired by said second one 14B of the three image acquisition units.

Furthermore, as shown in FIG. 8, the useful image displayed on the screen 18 may be made up of two image portions P1, P2 coming from two of the three image acquisition units 14A, 14B, 14C, in particular when the optical image forming means 30 of the two units 14A, 14B, 14C in question present angular fields of view that overlap in part, as shown in FIG. 7.

Thus, a useful video image can be displayed on the screen 18 occupying an apparent angular field of view that is greater than the angular field of view of any one of the image acquisition units 14A, 14B, 14C.

By means of the invention, the driver adjusts an appropriate selection from the initial image in application of criteria for this selection that are arbitrary, i.e. not predetermined. For this purpose, the user interface may include a manual control knob for adjusting the appropriate portion of the image that is selected.

1. A video data processor device for a motor vehicle, the device comprising at least one video image acquisition unit including means for generating an initial video image, the video image being defined by a video data set, means for transmitting data between the image acquisition unit and an on-board computer, and image-creator means for creating a useful video image from the initial video image, the device being characterized in that the image-creator means comprise adjustable selector means for selecting at least a portion of the initial video image, the selected portion constituting at least a portion of the useful image.

2. A device according to claim 1, wherein the video image acquisition unit includes means for forming an optical image having an angular field of view greater than 120°, from which the initial video image is generated.

3. A device according to claim 2, wherein the means for forming the optical image comprise a fish-eye type lens.

4. A device according to claim 1, wherein the image-creator means include means for adjustably selecting at least two portions of the initial video image, the selected portions constituting at least two portions of the useful image.

5. A device according to claim 1, having two video image acquisition units, the useful video image being constituted by two portions selected respectively from the two initial video images generated respectively by the two video image acquisition units.

6. A device according to claim 2, wherein the image-creator means include means for adjustably selecting at least two portions of the initial video image, the selected portions constituting at least two portions of the useful image.

7. A device according to claim 3, wherein the image-creator means include means for adjustably selecting at least two portions of the initial video image, the selected portions constituting at least two portions of the useful image.

8. A device according to claim 2, having two video image acquisition units, the useful video image being constituted by two portions selected respectively from the two initial video images generated respectively by the two video image acquisition units.

9. A device according to claim 3, having two video image acquisition units, the useful video image being constituted by two portions selected respectively from the two initial video images generated respectively by the two video image acquisition units.
